(19) United States
(12) Patent Application Publication
(10) Pub. No.: US 2015/0013874 A1
(43) Pub. Date: Jan. 15, 2015

(54) Method for jacketing elongate material, especially leads or cable looms

(71) Applicant: tesa SE, Hamburg (DE)

(72) Inventors: Michael Siebert, Schenefeld (DE); Andreas Schmidlin, Guderhandviertel (DE); Steve Zielinski, Brighton, MI (US)

(21) Appl. No.: 13/940,325

(22) Filed: Jul. 12, 2013

(51) Int. Cl. H01B 13/00

(52) U.S. Cl. CPC H01B 13/0013
USPC 156/52

(57) ABSTRACT

Method for jacketing elongate material such as more particularly leads or cable looms, where
an adhesive tape comprising a textile carrier and a curable adhesive applied to at least one side of the carrier is passed in a helical line around the elongate material, or the elongate material is wrapped in the axial direction by the adhesive tape,
the elongate material together with the adhesive tape wrapping is brought into the desired disposition, more particularly into the cable loom plane,
the elongate material is held in this disposition,
the curable adhesive is brought to cure by the supply of radiant energy such as heat.

The invention relates to a method for jacketing elongate material such as more particularly leads or cable looms.

Adhesive tapes have long been used in industry for producing cable harnesses. In this utility the adhesive tapes serve to bundle a multiplicity of electrical leads prior to installation or in already assembled state, in order to reduce the space taken up by the bundle of leads, by bandaging them, and also, in addition, to obtain protective functions.

Widely encountered are cable wrapping tapes with film and textile carriers, which in general are coated on one side with various pressure-sensitive adhesives.

Fundamentally, present cable looms wrapped with adhesive tape are initially flexible. In order to hold the individual strands of the cable loom in a particular form, to allow them to be guided around the engine without making contact with it, in the engine compartment, for example, it is usual to use injection-moulded components that are attached subsequently.

A fundamental drawback of these injection-moulded components is that additional expenditure on material and on assembly is entailed.

In the event of changes to the cable loom routing, a new form must be produced for such injection-moulded components, and this gives rise to considerable extra cost. This is especially the case when subsequent changes are made to the cable loom routing, as is a regular occurrence as part of the “facelifting” of more modern motor vehicles.

The textbook “Faserverbund-Kunststoffe” [Fibre composite plastics] by G. W. Ehrenstein, Hanser, 2006, ISBN 3-446-22716-4 discloses the use of fibres (especially glass fibres or polyester fibres) in combination with resins (especially epoxy resins) for producing fibre composite plastics.

EP 2 497 805 A1 describes an adhesive tape which finds use for the jacketing of elongate material such as cable looms in an automobile. The adhesive tape consists of a carrier with a top face and a bottom face, the carrier having a width B_{T} relative to the transverse direction, and having on at least one longitudinal edge an adhesive strip comprising a reactive, heat-activatable adhesive, with a width B_{K} of at least 3 mm and of not more than 50% of the width B_{T}.

For jacketing, the elongate material is wrapped in the axial direction by the adhesive tape. The reactive, curing adhesive leads to a flexible tube with very high fastening strength, since a “structural bond” is formed, but not a stiff, shaping assembly.

It is an object of the present invention to provide a method that allows particularly simple, inexpensive and quick jacketing of elongate material such as, more particularly, leads or cable looms, and that leads to a stiffened jacketed material.

This object is achieved by means of a method as recorded in the main claim. The dependent claims provide advantageous developments of the method.

The invention provides a method for jacketing elongate material such as more particularly leads or cable looms, where
an adhesive tape comprising a textile carrier and a curable adhesive applied to at least one side of the carrier is passed in a helical line around the elongate material, or the elongate material is wrapped in the axial direction by the adhesive tape,
the elongate material together with the adhesive tape wrapping is brought into the desired disposition, more particularly into the cable loom plane,
the elongate material is held in this disposition,
the curable adhesive is brought to cure by the supply of radiant energy such as heat.

A cable loom plan corresponds to the actual spatial disposition of the individual cable strands in the cable loom: that is, which cable strand is bent at which point in which angle, where positions of branches or outbindings are located, and which plugs are fitted to the ends of the cable strands.

In principle, during the coating on a textile carrier, any adhesive penetrates the textile carrier so as to be able to be anchored in it. In this process, the adhesive flows around the individual fibres or yarns, and so the layer of adhesive can no longer be separated from the carrier.

The anchoring is typically so strong that an adhesive tape of this kind can be readily unwound from a roll without the anchoring of the adhesive tearing and so-called transfer of the adhesive occurring (the adhesive in that case is on the reverse face of the carrier). Furthermore, it is expected of the majority of pressure-sensitive adhesive tapes that they can be detached again from the substrate—that is, can be taken up again as far as possible without trace. This means that adhesive tape must not fracture adhesively between carrier and adhesive.

According to one preferred embodiment of the invention, the adhesive, following application to the carrier, has sunken into the carrier to an extent of more than 10%, preferably more than 25%, more preferably more than 50%.

A numerical figure of 25% here, for example, means that the adhesive has penetrated over a layer thickness of 25% of the thickness of textile carrier, i.e., in the case of a carrier having a thickness of 100 μm, over a layer thickness of 25 μm within the carrier, this figure being applied starting from the surface of the carrier to which the adhesive has been coated, and in perpendicular direction with respect to the plane defined by the longitudinal or transverse direction, respectively.

According to one preferred embodiment, the amount of coated adhesive is selected such that there is still a good part of the partially sunken-in layer of adhesive projecting above the carrier.

The thickness of the non-sunken-in layer of adhesive is preferably more than 25 μm, more preferably more than 50 μm, more preferably more than 100 μm.

After curing, more particularly after thermally induced curing, the adhesive leads to a structural bond and hence to stiffening of the carrier, with the position of the carrier fibres or threads being fixed relative to one another.

With further preference, the carrier, after the adhesive has been applied, is saturated completely—that is, over 100% of the carrier thickness—with the adhesive, and so all of the carrier fibres are fixed. With this variant of the invention as well, the amount of adhesive applied can be selected so that still a partial layer of the adhesive projects above the carrier.

According to one embodiment, the adhesive tape is passed in a helical line around the elongate material. The wrapping is preferably done such that the new ply of adhesive tape overlaps the one located below it partially, preferably to an extent of 50%.

With further preference the adhesive tape may be passed a second time around the material. This second wrapping preferably takes place likewise in the form of a helical line, preferably with an offset. Wrapping in this case may take place in the same direction as the first wrapping, in other words likewise from left to right, but may also take place in the opposite direction.

In one particularly advantageous adhesive tape the carrier used is a woven, nonwoven or knitted fabric and/or the adhesive used is a reactive, heat-activatable adhesive comprising nitrile rubber and phenolic resin.

Adhesive tapes with carriers of these kinds can be torn into by hand with relative convenience, and this is likewise of particular importance for the described utility and the particularly preferred processing as a wrapping tape for bundling cables in automobiles.

A tensile strength in transverse direction of less than 10 N, determined in accordance with the AFERA standard 4007, serves as a criterium for the hand tearability of the adhesive tape.

Only in the case of very high basis weights or thicknesses on the part of the carriers employed is it possible that the hand tearability may not exist or may be limited. In that case, however, perforations may be present in order to optimize the hand tearability.

As carrier it is possible to use all known textile carriers such as knitted fabrics, scrims, tapes, braids, tufted textiles, felts, woven fabrics (encompassing plain weave, twill and satin weave), knitted fabrics (encompassing warp knits and other knits) or nonwoven webs, the term “nonwoven web” comprehending at least sheetlike textile structures in accordance with EN 29092 (1988) and also stitchbonded webs and similar systems.

It is likewise possible to use woven and knitted spacer fabrics with lamination.

Spacer fabrics of these kinds are disclosed in EP 0 071 212 B1. Spacer fabrics are mat-like layer structures comprising a cover layer of a fibre or filament web, an underlayer and individual retaining fibres or bundles of such fibres between these layers, these fibres being distributed over the area of the layer structure, being needled through the particle layer and joining the cover layer and the underlayer to one another. As an additional although not mandatory feature, the retaining fibres in accordance with EP 0 071 212 B1 contain particles of inert minerals, such as sand, gravel or the like, for example.

The retaining fibres needled through the particle layer hold the cover layer and the underlayer at a distance from one another and are joined to the cover layer and the underlayer.

Nonwovens contemplated include, in particular, consolidated staple fibre webs, but also filament webs, meltblown webs and spunbonded webs, which generally require additional consolidation. Possible consolidation methods known for webs include mechanical, thermal and chemical consolidation. Whereas with mechanical consolidations the fibres are held together purely mechanically usually by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to fibre nodal points, so that a stable, three-dimensional network is formed while nevertheless retaining the relatively loose, open structure in the web.

Webs which have proved to be particularly advantageous are those consolidated in particular by overstitching with separate threads or by interlooping.

Consolidated webs of this kind are produced for example on stitchbonding machines of the “Malimo” type from the company Karl Mayer, formerly Malimo, and can be obtained from companies including Hoftex Group AG. A Malifleece is characterized in that a cross-laid web is consolidated by the formation of loops from fibres of the web.

The carrier used may also be a web of the Kunit or Multilknit type. A Kunit web is characterized in that it originates from the processing of a longitudinally oriented fibre web to form a sheetlike structure which has loops on one side and has loop feet or pile fibre folds on the other side, but possesses neither threads nor prefabricated sheetlike structures. A web of this kind as well has been produced for a relatively long time, for example on stitchbonding machines of the “Malimo” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fibre nonwovens produced by the Kunit process. In the end product, both top sides of the nonwovens are shaped by means of interlooped fibres to form a closed surface, and are joined to one another by fibres which stand almost perpendicularly. An additional possibility is to introduce further needlable sheetlike structures and/or scatterable media.

Finally, stitchbonded webs as an intermediate are also suitable for forming a carrier of the invention and an adhesive tape of the invention. A stitchbonded web is formed from a nonwoven material having a large number of stitches extending parallel to one another. These stitches are brought about by the stitching-in or stitchbonding of continuous textile threads. For this type of web, stitchbonding machines of the “Malimo” type from the company Karl Mayer are known.

Also particularly suitable are needlefelt webs. In a needlefelt web, a tuft of fibres is made into a sheetlike structure by means of needles provided with barbs. By alternate introduction and withdrawal of the needles, the material is consolidated on a needle bar, with the individual fibres interlooping to form a firm sheetlike structure. The number and configuration of the needling points (needle shape, penetration depth, double-sided needling) determine the thickness and strength of the fibre structures, which are in general lightweight, air-permeable and elastic.

Also particularly advantageous is a staple fibre web which is mechanically preconsolidated in the first step or is a wet-laid web laid hydrodynamically, in which between 2% and 50% by weight of the web fibres are fusible fibres, more particularly between 5% and 40% by weight of the web fibres.

A web of this kind is characterized in that the fibres are laid wet or, for example, a staple fibre web is preconsolidated by the formation of loops from fibres of the web by needling, stitching, air-jet and/or water-jet treatment.

In a second step, thermofixing takes place, with the strength of the web being increased again by the melting, or partial melting, of the fusible fibres.

For the utilization of nonwovens in accordance with the invention, the adhesive consolidation of mechanically preconsolidated or wet-laid webs is of particular interest, it being possible for said consolidation to take place by way of the addition of binder in solid, liquid, foamed or paste-like form. A great diversity of theoretical presentation forms is possible: for example, solid binders as powders for trickling in; as a sheet or as a mesh; or in the form of binding fibres. Liquid binders may be applied as solutions in water or organic solvents, or as a dispersion. For adhesive consolidation, binding dispersions are predominantly selected: thermosets in the form of phenolic or melamine resin dispersions, elastomers as dispersions of natural or synthetic rubbers or, usually, dispersions of thermoplastics such as acrylates, vinyl acetates, polyurethanes, styrene-butadiene systems, PVC, and the like, and also copolymers thereof. Normally the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” [Nonwovens] (Georg Thieme Verlag, Stuttgart, 1982) or

“Textiltechnik-Vliesstofferzeugung” [Textile Technology—Producing Nonwovens] (Arbeitgeberkreis Gesamttextil, Eschborn, 1996).

For sufficient adhesive consolidation of the web carrier, the addition of binder in the order of magnitude of 1% to 50%, more particularly 3% to 20%, based on the weight of the fibre web, is generally required.

The binder may be added as early as during the manufacture of the web, in the course of mechanical preconsolidation, or else in a separate process step, which may be carried out in-line or off-line. Following the addition of binder, it is necessary temporarily to generate a condition for the binder in which the binder becomes adhesive and adhesively connects the fibres—this may be achieved during the drying, for example, of dispersions, or else by means of heating, with further possibilities for variation existing by way of areal or partial application of pressure. The binder may be activated in known drying tunnels, given an appropriate selection of binder, or else by means of infra-red radiation, UV radiation, ultra-sound, high-frequency radiation or the like. For the subsequent end use it is sensible, though not absolutely necessary, for the binder to have lost its tack following the end of the web production process. It is advantageous that, as a result of thermal treatment, volatile components such as fibre assistants are removed, giving a web having favourable fogging values, so that when a low-fogging adhesive is used, it is possible to produce an adhesive tape having particularly favourable fogging values; accordingly, the liner as well has a very low fogging value.

Advantageously and at least in regions, the carrier may have a single-sidedly or double-sidedly polished surface, preferably in each case a surface polished over the whole area. The polished surface may be chintzed, as elucidated in detail in EP 1 448 744 A1, for example. Dirt repellency is hereby improved.

Starting materials for the carrier are more particularly (manmade) fibres (staple fibre or continuous filament) made from synthetic polymers, also called synthetic fibres, made from polyester such as polyethylene terephthalate, polyamide, polyimide, aramid, polyolefin, polyacrylonitrile or glass, (manmade) fibres made from natural polymers such as cellulosic fibres (viscose, Modal, Lyocell, Cupro, acetate, triacetate, Cellulon), such as rubber fibres, such as plant protein fibres and/or such as animal protein fibres and/or natural fibres made of cotton, sisal, flax, silk, hemp, linen, coconut or wool. The present invention, however, is not confined to the materials stated; it is instead possible, as evident to the skilled person without having to take an inventive step, to use a multiplicity of further fibres in order to produce the nonwoven.

Likewise suitable, furthermore, are yarns fabricated from the fibres specified.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials.

Preferred material used for the carrier is polyester or glass, more preferably polyester, owing to the outstanding ageing resistance and the outstanding resistance to media, namely with respect to chemicals and service fluids such as oil, fuel, antifreeze and similar. Polyester and glass, moreover, have the advantages that they lead to a very abrasion-resistant and temperature-stable carrier, which is particularly important for the specific utility for the bundling of cables in automobiles and, for example, in the engine compartment.

The basis weight of the textile carrier is advantageously between 30 g/m² and 300 g/m², more advantageously between 50 g/m² and 200 g/m², very advantageously between 60 g/m² and 150 g/m², especially advantageously between 70 g/m² and 100 g/m².

According to one particularly advantageous embodiment of the invention the carrier used is a woven or nonwoven polyester fabric which has a basis weight of between 60 g/m² and 150 g/m².

According to one advantageous embodiment of the invention the curable adhesive is self-adhesive, or a layer of self-adhesive is applied at least partially to the curable adhesive.

The adhesive tape can then be used to bundle cables, and/or the adhesive tape can be affixed to the cable loom by spiral wrapping without further aids.

A self-adhesive, also called pressure-sensitive adhesive, is an adhesive which even under relatively weak applied pressure, permits durable bonding to virtually all substrates and which, after service, can be detached from the substrate again substantially without residue. At room temperature, a pressure-sensitive adhesive has a permanent pressure-sensitive adhesion effect—that is, it exhibits a sufficiently low viscosity and a high initial tack, and so it wets the surface of the respective substrate under just low applied pressure. The bondability of the adhesive derives from its adhesive properties, and the redetachability on its cohesive properties.

The stiffness of the cable loom can be increased by means of a self-adhesive composition because the adhesive as well bonds to the cables of the cable loom and so fixes their position relative to one another and to the surrounding (already stiff) carrier.

In accordance with the invention the curable adhesive is understood to be a structural adhesive (construction adhesive, assembly adhesive) (see Rompp, Georg Thieme Verlag, document code RD-19-04489, last update: September 2012). Structural adhesives, according to DIN EN 923: 2006-01, are adhesives which form adhesive bonds which within a structure are able to retain a specified strength for a specified, relatively long time period (according to ASTM definition: “bonding agents used for transferring required loads between adherends exposed to service environments typical for the structure involved”). They are, therefore, adhesives for bonds which can be subjected to high chemical exposures and physical loads and which, in the cured state, contribute to strengthening the bonded substrates and are used for producing constructions from metals, ceramic, concrete, wood or reinforced plastics. The structural adhesives of the invention are based more particularly on (heat-curable) reactive adhesives (phenolic resins, epoxy resins, polyimides, polyurethanes et cetera).

The curable adhesive may be elastic after curing, in order to ensure long-term jacketing insensitive to instances of vibration and twisting.

Adhesives used are, in particular, reactive, heat-activatable adhesives.

These adhesives possess a very good dimensional stability if the elastomeric component has a high elasticity. Moreover, the reactive resins mean that a crosslinking reaction can occur, significantly increasing the bond strength. Thus, for example, heat-activatable adhesives based on nitrile rubbers and phenolic resins can be employed, available commercially, for example, in the tesa® 8401 product from tesa.

According to one advantageous embodiment, the adhesive consists at least of

a) a polyamide having amino and/or acid end groups,

b) an epoxy resin,

c) optionally a plasticizer, the polyamide reacting with the epoxy resin at temperatures of at least 150° C., and the ratio in weight fractions of a) and b) lying between 50:50 to 99:1.

With further preference the adhesive consists of

i) a thermoplastic polymer with a fraction of 30 to 89.9 wt %,

ii) one or more tackifying resins, with a fraction of 5 to 50 wt %, and/or

iii) epoxy resins with hardeners, optionally also accelerators, with a fraction of 5 to 40 wt %.

This adhesive is a mixture of reactive resins which crosslink at room temperature and form a three-dimensional, high-strength polymer network, and of permanently elastic elastomers, which counteract embrittlement of the product. The elastomer may come preferably from the group of the polyolefins, polyesters, polyurethanes or polyamides, or may be a modified rubber, such as nitrile rubber, for example.

The especially preferred thermoplastic polyurethanes (TPU) are known reaction products of polyester polyols or polyether polyols and of organic diisocyanates such as diphenylmethane diisocyanate. They are constructed from predominantly linear macromolecules. Such products are available commercially mostly in the form of elastic pellets, as for example from Bayer AG under the trade name “Desmocoll”.

Through combination of TPU with selected compatible resin it is possible to lower the softening temperature of the adhesive. Occurring in parallel with this, indeed, is an increase in the adhesion. Resins which have proved to be suitable include, for example, certain rosins, hydrocarbon resins and coumarone resins.

Alternatively to this, the reduction in the softening temperature of the adhesive can be achieved by combining TPU with selected epoxy resins based on bisphenol A and/or F and a latent hardener. An adhesive comprising such a system allows the joint to harden subsequently, either gradually at room temperature without any further external intervention, or in a short time by means of controlled heating.

As a result of the chemical crosslinking reaction of the resins, high strengths are obtained between the adhesive and the carrier, and a high internal strength is achieved in the product.

The addition of these reactive resin/hardener systems here also leads to a lowering of the softening temperature of the abovementioned polymers, which has the advantageous effect of lowering their processing temperature and processing speed. The suitable product is a product which is self-adhesive at room temperature or slightly elevated temperatures. On heating of the product, there is also a lowering of the viscosity for a short time, allowing the product to wet even rough surfaces.

The compositions for the adhesive can be widely varied by modifying the nature and proportion of the raw materials. Similarly, further product properties, such as colour, and thermal or electrical conductivity, for example, can be achieved by specific additions of colorants, mineral or organic fillers and/or carbon powders or metal powders.

Nitrile rubbers which can be employed in adhesives of the invention include in particular all acrylonitrile-butadiene copolymers with an acrylonitrile content of 15 to 50 wt %. Use may also be made of copolymers of acrylonitrile, butadiene and isoprene. The fraction of 1,2-linked butadiene here is variable. The aforementioned polymers may be hydrogenated to varying degrees and fully hydrogenated polymers with a double fraction of below 1% can also be utilized.

All of these nitrile rubbers are carboxylated to a certain degree, the fraction of the acid groups being preferably 2 to 15 wt %. Systems of these kinds are available commercially, for example, under the name Nipol 1072 or Nipol NX 775 from Zeon. Hydrogenated carboxylated nitrile rubbers are commercialized under the name Therban XT VP KA 8889 by Lanxess.

To increase the adhesion, the addition of tackifier resins compatible with the nitrile rubbers is also possible.

Epoxy resins are typically understood to include both monomeric and oligomeric compounds having more than epoxy group per molecule. These compounds may be reaction products of glycidyl esters or epichlorohydrin with bisphenol A or bisphenol F or mixtures of these two. Likewise possible for use are epoxy novolak resins obtained by reacting epichlorohydrin with the reaction product of phenols and formaldehyde. Monomeric compounds having two or more epoxide end groups, which are employed as diluents for epoxy resins, can also be used. It is likewise possible to employ elastically modified epoxy resins.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071, 1079 likewise from Shell Chemicals, and Bakelite™ EPR 161, 166, 172, 191, 194 etc. from Bakelite AG.

Commercial aliphatic epoxy resins are, for example, vinylcyclohexane dioxides such as ERL-4206, 4221, 4201, 4289 or 0400 from Union Carbide Corp.

Elasticized epoxy resins are available from Noveon under the name Hycar.

Epoxide diluents, monomeric compounds having two or more epoxide groups, are, for example, Bakelite™ EPD KR, EPD Z8, EPD HD, EPD WF, etc. from Bakelite AG, or Polypox™ R 9, R12, R 15, R 19, R 20 etc. from UCCP.

With further preference the adhesive comprises more than one epoxy resin.

Examples of Novolak resins which can be used include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epicote™ 152 from Shell Chemical.

As reactive resins it is also possible, furthermore, to use melamine resins, such as Cymel™ 327 and 323 from Cytec, for example.

As reactive resins it is also possible, furthermore, to use terpene-phenolic resins such as NIREZ™ 2019 from Arizona Chemical, for example.

As reactive resins it is also possible, furthermore, to use phenolic resins such as YP 50 from Toto Kasei, PKHC from Union Carbide Corp. and BKR 2620 from Showa Union Gosei Corp., for example.

As reactive resins it is also possible, furthermore, to use phenol resole resins, including in combination with other phenolic resins.

As reactive resins it is also possible, furthermore, to use polyisocyanates such as Coronate™ L from Nippon Polyurethan Ind., Desmodur™ N3300 or Mondur™ 489 from Bayer, for example.

In one advantageous version of the adhesive of the invention based on nitrile rubber there are additionally bond strength boosting (tackifying) resins added, very advantageously in a fraction of up to 30 wt %, based on the adhesive.

Tackifying resins to be added that can be used include without exception all tackifier resins already known and described in the literature. Those preferentially suitable include non-hydrogenated, partially hydrogenated or fully hydrogenated resins based on indene, rosin and rosin derivatives, hydrogenated polymers of dicyclopentadiene, non-hydrogenated or partially, selectively or fully hydrogenated hydrocarbon resins based on C₅, C₅/C₉ or C₉ monomer streams, polyterpene resins based on α-pinene and/or β-pinene and/or δ-limonene, or hydrogenated polymers of preferably pure C₈ to C₉ aromatics.

Any desired combinations of these and further resins may be used in order to adjust the properties of the resultant adhesive in line with requirements. Generally speaking, it is possible to use all resins that are compatible (soluble) with the polymer in question. Express reference is made to the detailing of the state of knowledge in the “Handbook of Pressure Sensitive Adhesive Technology” by Donatas Satas (van Nostrand, 1989).

Besides the acid-modified or acid anhydride-modified nitrile rubbers already mentioned, it is also possible for further elastomers to be employed. As well as further acid-modified or acid anhydride-modified elastomers, unmodified elastomers may also be employed, such as, for example, polyvinyl alcohol, polyvinyl acetate, styrene block copolymers, polyvinyl formal, polyvinyl butyral or soluble polyesters.

Copolymers with maleic anhydride can be employed as well, such as, for example, a copolymer of polyvinyl methyl ether and maleic anhydride, obtainable for example under the name Gantrez™, sold by ISP.

The chemical crosslinking of the resins with the elastomers produces very high strengths within the adhesive.

Further additives which can typically be utilized include the following:
primary antioxidants such as, for example, sterically hindered phenols
secondary antioxidants such as, for example, phosphites or thioethers
in-process stabilizers such as, for example, C radical scavengers
light stabilizers such as, for example, UV absorbers or sterically hindered amines
processing assistants
fillers such as, for example, silicon dioxide, glass (ground or in the form of beads), aluminium oxides, zinc oxides, calcium carbonates, titanium dioxides, carbon blacks, metal powders, etc
colour pigments and dyes and also optical brighteners.

Through the use of plasticizers it is possible to increase the elasticity of the crosslinked adhesive. Plasticizers which can be used in the context include for example low molecular mass polyisoprenes, polybutadienes, polyisobutylenes or polyethylene glycols and polypropylene glycols, or plasticizers based on polyethylene oxides, phosphate esters, aliphatic carboxylic esters and benzoic esters. It is also possible, furthermore, to employ aromatic carboxylic esters, diols of relatively high molecular mass, sulphonamides and adipic esters.

Since the nitrile rubbers used, even at high temperatures, do not possess too low a viscosity, there is no escape of the adhesive from the bond line during adhesive bonding and hot pressing. During this operation, the epoxy resins crosslink with the elastomers, producing a three-dimensional network.

Through the addition of what are called accelerators it is possible to achieve a further increase in the reaction rate.

Accelerators may be, for example, the following:
tertiary amines such as benzyldimethylamine, dimethylaminomethylphenol and tris(dimethylaminomethyl)phenol
boron trihalide-amine complexes
substituted imidazoles
triphenylphosphine.

Examples of suitable accelerators include imidazoles, available commercially as 2M7, 2E4MN, 2PZ-CN, 2PZ-CNS, P0505, L07N from Shikoku Chem. Corp. or Curezol 2MZ from Air Products. A further suitable crosslinker comprises additions of HMTA (hexamethylenetetramine).

It is additionally possible optionally to add fillers (for example fibres, carbon black, zinc oxide, titanium dioxide, chalk, hollow or solid glass beads, microbeads of other materials, silica, silicates), nucleators, expandants, bond strength booster additives and thermoplastics, compounding agents and/or ageing inhibitors, in the form for example of primary and secondary antioxidants or in the form of light stabilizers.

In a further preferred embodiment the adhesive is admixed with further additives, such as, for example, polyvinyl formal, polyacrylate rubbers, chloroprene rubbers, ethylene-propylene-diene rubbers, methyl-vinyl-silicone rubbers, fluorosilicone rubbers, tetrafluoroethylene-propylene copolymer rubbers, butyl rubbers and styrene-butadiene rubbers.

Polyvinylbutyrals are available as Butvar™ from Solucia, as Pioloform™ from Wacker and as Mowital™ from Kuraray. Polyacrylate rubbers are available as Nipol AR™ from Zeon. Chloroprene rubbers are available as Baypren™ from Bayer. Ethylene-propylene-diene rubbers are available as Keltan™ from DSM, as Vistalon™ from Exxon Mobil and as Buna EP™ from Bayer. Methyl-vinyl-silicone rubbers are available as Silastic™ from Dow Corning and as Silopren™ from GE Silicones. Fluorosilicone rubbers are available as Silastic™ from GE Silicones. Butyl rubbers are available as Esso Butyl™ from Exxon Mobil. Styrene-butadiene rubbers are available as Buna S™ from Bayer, as Europrene™ from Eni Chem and as Polysar S™ from Bayer.

Polyvinyl formals are available as Formvar™ from Ladd Research.

In a further preferred embodiment the adhesive is admixed with further additives, such as, for example, thermoplastic materials from the group of the following polymers: polyurethanes, polystyrene, acrylonitrile-butadiene-styrene terpolymers, polyesters, unplasticized polyvinyl chlorides, plasticized polyvinyl chlorides, polyoxymethylenes, polybutylene terephthalates, polycarbonates, fluorinated polymers, such as, for example, polytetrafluoroethylene, polyamides, ethylene-vinyl acetates, polyvinyl acetates, polyimides, polyethers, copolyamides, copolyesters, polyolefins such as, for example, polyethylene, polypropylene, polybutene, polyisobutene and poly(meth)acrylates.

The bond strength of the heat-activatable adhesive can be boosted by further specific additization. Thus, for example, polyimine copolymers or polyvinyl acetate copolymers can also be used as bond strength promoting adjuvants.

To produce the adhesive strip, the constituents of the adhesive are dissolved in a suitable solvent, butanone for example, and coated onto a flexible substrate provided with a release layer, for example a release paper or release film, and dried, allowing the composition to be easily removed again from the substrate. After corresponding conversion, diecuts, rolls or other shapes can be produced at room temperature. Corresponding shapes are then adhered to the carrier preferably at elevated temperature.

At the laminating temperature, the admixed epoxy resins do not as yet enter into any chemical reaction, but instead only react when the jacketing is produced from the adhesive tape of the invention, this reaction being with the acid or acid anhydride groups.

The adhesive crosslinks preferably at temperatures above 150° C.

The thickness of the applied adhesive is advantageously between 50 μm and 500 μm, more advantageously between 100 μm and 250 μm, very advantageously between 100 μm and 200 μm.

The adhesive tape, lastly, may have a liner material, with which the one or two layers of adhesive are covered until the time of use. Suitable liner materials include all of the materials set out comprehensively above.

Preference is given to using a non-linting material such as a polymeric film or a well-sized, long-fibre paper.

If low flammability is desired in the adhesive tape described, it can be achieved by the addition to the carrier and/or to the adhesive of flame retardants. These retardants may be organobromine compounds, if necessary with synergists such as antimony trioxide, although, with a view to the absence of halogen from the adhesive tape, preference will be given to using red phosphorous, organophosphorous compounds, mineral compounds or intumescent compounds such as ammonium polyphosphate, alone or in conjunction with synergists.

The general expression “adhesive tape” for the purposes of this invention encompasses all sheet-like structures as two-dimensionally extended sheets or sheet sections, tapes with extended length and limited width, tape sections and the like, lastly including diecuts or labels.

The adhesive tape may be produced in the form of a roll, in other words in the form of an archimedean spiral wound up onto itself. A reverse-face varnish may be applied on the reverse of the adhesive tape, in order to exert a favourable influence over the unwind properties of the adhesive tape wound to an archimedean spiral. This reverse-face varnish may for that purpose be furnished with silicone compounds or fluorosilicone compounds and also with polyvinyl stearylcarbamate, polyethyleniminestearylcarbamide or organofluorine compounds as dehesive (abhesive) substances and/or for non-stick coating.

The adhesive may be applied in the longitudinal direction of the adhesive tape, in the form of a stripe with a width lower than that of the adhesive tape carrier.

Depending on the specific utility, it is also possible for two or more parallel stripes of the adhesive to be coated on the carrier material. The position of the stripe on the carrier is freely selectable, with a disposition directly at one of the edges of the carrier being preferred.

The adhesive is preferably applied over the full area of the carrier.

If a certain fixing of the adhesive tape on the product is desired, the jacketing may be performed in such a way that the adhesive strip bonds partly to the adhesive tape itself and partly to the product.

With further preference, when the adhesive tape is bonded to cables with PVC jacketing and cables with polyolefin jacketing, the adhesive tape does not destroy that jacketing when an assembly of cables and adhesive tape is subjected in accordance with LV 312 to storage at temperatures above 100° C. for up to 3000 hours and the cable is subsequently bent around a mandrel. The adhesive tape of the invention is outstandingly suitable for the wrapping of cables, can be easily unwrapped for ease of processing, and exhibits no cable embrittlement even in the high temperature classes T3 and T4 over 3000 hours.

Particularly advantageous embodiments of the invention encompass the following adhesive tape versions:
Version 1: Adhesive on one side (carrier not completely penetrated)
   carrier: nonwoven or woven fabric: 30 g/m² to 300 g/m² (preferably of polyester)
   adhesive: 100 μm to 500 μm
   construction: the adhesive has penetrated the carrier to an extent of more than 10 but less than 100%.
Version 2: Adhesive on both sides (carrier not completely penetrated)
   carrier: nonwoven or woven fabric: 30 g/m² to 300 g/m² (preferably of polyester)
   adhesive: 100 μm to 500 μm
   construction: the adhesive has penetrated the carrier on both sides to an extent in each case of more than 10 but less than 50%.
Version 3: Carrier completely penetrated
carrier: nonwoven or woven fabric: 50 g/m² to 300 g/m² (preferably of polyester)
   adhesive: 100 μm to 500 μm
   construction: the adhesive has penetrated 100% into the carrier and projects by at least 25 μm above the carrier.
Version 4: A plurality of carriers, not fully penetrated. The version is of particular advantage when the elongate material is wrapped in axial direction by the adhesive tape.
   construction (from bottom to top)
      adhesive: 100 μm to 500 μm
      carrier: nonwoven or woven fabric: 50 g/m² to 300 g/m² (preferably of polyester)
      adhesive: 100 μm to 500 μm
      carrier: nonwoven or woven fabric: 50 g/m² to 300 g/m² (preferably of polyester)
      and optionally continuing.
      The topmost layer may be either a composition or a carrier.
      The carriers may, as and when necessary, be partly or fully penetrated.

In the text below, the aim is to elucidate the adhesive tape in more detail, by way of example, using a number of figures, without the invention being confined to these embodiments.

### BRIEF DESCRIPTION OF THE DRAWINGS

FIG. 1 shows the adhesive tape in lateral section;

FIG. 2 shows a detail of a cable loom which is composed of a bundle of individual cables and is jacketed with the adhesive tape of the invention.

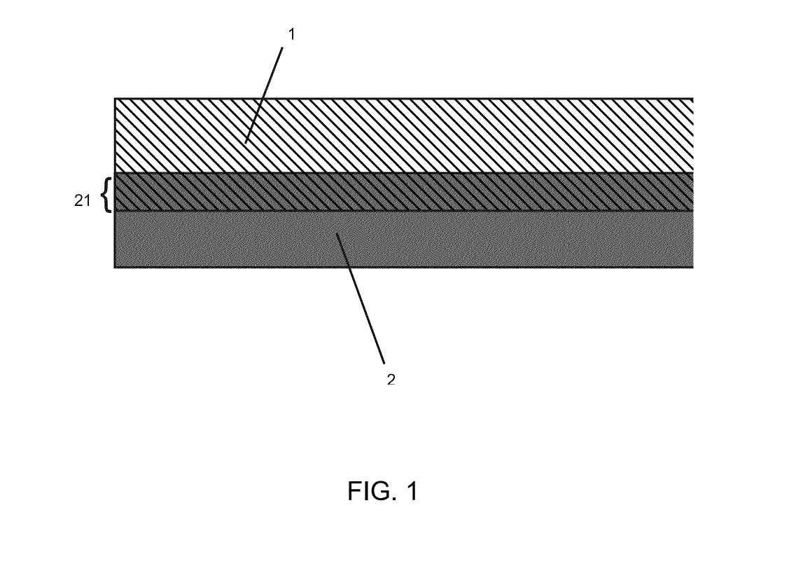

FIG. 1 shows a sectional view in transverse direction (transverse section) of the adhesive tape, consisting of a nonwoven carrier 1, one side of which bears an applied layer of a curable adhesive 2, which additionally is self-adhesive.

The adhesive has sunken into the carrier to an extent of 25%, thereby producing optimum anchorage.

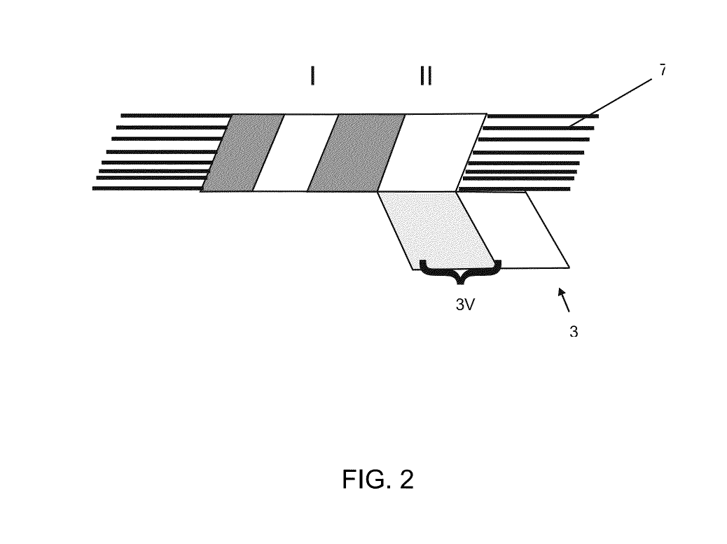

FIG. 2 shows a detail of a cable loom which is composed of a bundle of individual cables 7 and which is jacketed with the adhesive tape 3 of the invention, here depicted in simplified form, according to the version described in FIG. 1. The adhesive tape 3 is passed in a spiral movement around the cable loom.

The detail of the cable loom that is shown shows two turns I and II of the adhesive tape 3. Further turns would extend to the left; these turns have not been shown here.

The wrapping of the adhesive tape 3 takes place with an offset 3V of 50%, which in this figure is indicated by the darker colour.

### EXAMPLES

The adhesive tape of the invention is described in preferred embodiment below, on the basis of a number of examples, without thereby wishing to restrict the invention in any way.

### Example 1

### Nonwoven Web Furnished on One Side with a Heat-Activatable Adhesive

Carrier: Maliwatt web at 70 g/m²
adhesive: nitrile rubber and phenolic resin.

The Maliwatt carrier is subjected to hot lamination with the nitrile rubber-based and phenolic resin-based adhesive at a temperature of 130° C., producing 25% penetration of the carrier by the adhesive. The laminator utilized is a LM 260 pouch laminator (S2 Laminiertechnik GmbH) at a temperature of 130° C. One pass through the laminator is made.

In the jacketing of a cable harness, the adhesive tape is passed with an overlap of 50% in a helical line around eight cores of a cable with ETFE sheathing. The jacketed cables have a length of 120 mm.

This is followed by measurement of the flexural stiffness F1 by a method analogous to LV112 “flexural force of leads”. The distance Iv is 100 mm. The flexural force F1 is measured after 15 mm deformation (only one flexing).

The cable harness is subsequently cured in a forced-air oven at 175° C. for 15 minutes.

This is followed by measurement of the flexural stiffness F2 by a method analogous to LV112 “flexural force of leads”. The distance Iv is 100 mm. The flexural force F2 is measured after 15 mm deformation (only one flexing).

### Example 2

### Nonwoven Web Furnished on Both Sides with a Heat-Activatable Adhesive

Carrier: Maliwatt web at 70 g/m²
adhesive: nitrile rubber and phenolic resin.

The Maliwatt carrier is subjected to hot lamination on both sides with a nitrile rubber-based and phenolic resin-based adhesive at a temperature of 130° C., producing 25% penetration of the carrier by the adhesive in each case. The laminator utilized is a LM 260 pouch laminator (S2 Laminiertechnik GmbH) at a temperature of 130° C. One pass through the laminator is made.

In the jacketing of a cable harness, the adhesive tape is passed with an overlap of 50% in a helical line around 16 cores of a cable with ETFE sheathing. The jacketed cables have a length of 120 mm.

This is followed by measurement of the flexural stiffness F1 by a method analogous to LV112 “flexural force of leads”. The distance Iv is 100 mm. The flexural force F1 is measured after 15 mm deformation (only one flexing).

The cable harness is subsequently cured in a forced-air oven at 175° C. for 15 minutes.

This is followed by measurement of the flexural stiffness F2 by a method analogous to LV112 “flexural force of leads”. The distance Iv is 100 mm. The flexural force F2 is measured after 15 mm deformation (only one flexing).

| | Sample | F1 | F2 |
|---|---|---|---|
| | diameter | (15 mm) | (15 mm) |
| Specimen | [mm] | [N] | [N] |
| Version 1, Maliwatt, 200 μm | 10 | 41.6 | 128.5 |
| composition | | | |
| Version 1, Maliwatt, 200 μm | 13 | 32.1 | 141.1 |
| composition, doubly wrapped | | | |
| Version 1, Maliwatt, 125 μm | 10 | 39.4 | 98.1 |
| composition | | | |
| Version 1, Maliwatt, 125 μm | 13 | 35.7 | 121.2 |
| composition doubly wrapped | | | |
| Version 2, Maliwatt, 200 μm | 12 | 31.7 | 201.4 |
| composition | | | |
| Version 1, needlefelt web, 200 μm | 11 | 38.0 | 76.3 |
| composition | | | |
| Version 1, needlefelt web, 200 μm | 17 | 39.3 | 90.1 |
| composition, doubly wrapped | | | |
| Version 1, needlefelt web, 125 μm | 13 | 43.0 | 71.6 |
| composition | | | |
| Version 1, needlefelt web, 125 μm | 15 | 49.72 | 100.0 |
| composition, doubly wrapped | | | |

Maliwatt: 72 g/m², polyester
Needlefelt web: 100 g/m²
Composition 270 μm: HAF 8400
Composition 125 μm: HAF 8475
tesa ® HAF 8475 and tesa ® HAF 8400 are each a carrier-less, heat-activatable film based on nitrile rubber and phenolic resin.

A comparison of the versions with Maliwatt with those with a needlefelt web shows that the internal strength of the needlefelt web is much less than that of the Maliwatt, and hence a substantially lower flexural stiffness is obtained.

1. Method for jacketing elongate material such as more particularly leads or cable looms, where
an adhesive tape comprising a textile carrier and a curable adhesive applied to at least one side of the carrier is passed in a helical line around the elongate material, or the elongate material is wrapped in the axial direction by the adhesive tape,
the elongate material together with the adhesive tape wrapping is brought into the desired disposition into the cable loom plane,
the elongate material is held in this disposition,
the curable adhesive is brought to cure by the supply of radiant energy such as heat.

2. Method according to claim 1,
wherein
the adhesive, following application to the carrier, has sunken into the carrier to an extent of more than 10%.

3. Method according to claim 1,
wherein
the adhesive, following application to the carrier, completely saturates the carrier.

4. Method according to claim 1,
wherein
the curable adhesive is self-adhesive or a layer of self-adhesive is applied at least partially to the curable adhesive.

5. Method according to claim 1,
wherein
the carrier has a basis weight of 30 to 300 g/m².

6. Method according to claim 1,
wherein
a woven, nonwoven or knitted fabric is used as carrier.

7. Method according to claim 1,
wherein
the carrier consists of polyester or of glass fibres.

8. Method according to claim 1,
wherein
a reactive, heat-activatable adhesive comprising nitrile rubber and phenolic resin is used as curable adhesive.
